(19) United States
(12) Patent Application Publication
(10) Pub. No.: US 2015/0185069 A1
(43) Pub. Date: Jul. 2, 2015

(54) METHOD AND APPARATUS FOR DETERMINING A FREQUENCY LINE PATTERN WITHIN AT LEAST ONE AMPLITUDE SPECTRUM

(71) Applicant: ATLAS ELEKTRONIK GmbH, Bremen (DE)

(72) Inventor: Gregor Meerpohl, Wildeshausen (DE)

(21) Appl. No.: 14/419,487

(22) PCT Filed: Jul. 2, 2013
(86) PCT No.: PCT/DE2013/100242

§ 371 Date: Feb. 4, 2015

(30) Foreign Application Priority Data
Aug. 7, 2012 (DE) 102012015637.5

(51) Int. Cl. G01H 3/08; G01S 3/80

(52) U.S. Cl. CPC G01H 3/08; G01S 3/80

(57) ABSTRACT

The invention relates to a method for determining a frequency line pattern within at least one amplitude spectrum generated from acoustic signals that are emitted from at least one detected vehicle and received by means of a sonar installation. First, a predetermined number of frequency lines is selected in the (or each) amplitude spectrum, and by sorting them on their amplitude size and on the basis of a threshold value which ensures that the pre-determined, appropriate number is not exceeded. After several threshold values are set, a comparison of frequency lines with each other takes place for those that have been selected taking into account at least one threshold value. The preliminary frequency line set with associated fundamental frequency, evaluated because of its recognizable structures, is then determined, by comparing the line pairs formed. Using a process of elimination, final frequency line sets are formed, under consideration of an assessment which depends on the sequence, number, density, and amplitude of the fundamental frequency of the frequency lines. Then strong individual lines can be found, which are possibly contained in the spectrum. A target-related frequency line pattern is assigned to each detected vehicle, based on which the classification of the vehicle becomes possible.

The invention further relates to a corresponding apparatus for carrying out the given method.

The invention relates to a method for determining a frequency line pattern within at least one amplitude spectrum type mentioned in the preamble of claim 1, and an apparatus for carrying out such a method according to the preamble of claim 15.

Considering the current state of waterborne sound technology, it is well known that water vessels, such as ships, submarines, underwater running bodies and others can be detected and classified according to the operating noise emitted by them. Such a detection and classification of aircraft vehicles such as airplanes and helicopters is also possible from the airborne-sound technology.

The operating noise of a water vessel is mainly caused by its engines and received by a sonar system. Due to the driving propellers, turbines, generators and/or pumps, the amplitude spectrum generated by the frequency spectrum of the received noise shows significant frequency lines.

Known algorithms for the classification of vehicles based on the operating noise emitted require the frequency line pattern as completely as possible by the way of input data. Based on the frequency line pattern, the information on the fundamental frequency, the elevation pattern as well as any existing duplicates can be obtained under the frequency lines of an associated vehicle.

With the help of a set of rules and a database, the operating data of the classifiable vehicle can be determined, resulting in the corresponding classification.

Conventionally, the required input data for the classification algorithm must be given manually by an operator. This input is usually done by means of graphic input tools, which usually result in wasting a lot of time during classification. It is also possible that, with a manual input, existing information may be overlooked or entered with insufficiently accuracy.

EP 0 654 676 B1 discloses a method for determining one or more fundamental frequencies and/or its harmonics in the frequency spectrum of a received signal of an acoustic positioning system. Fundamental frequencies are then determined based on three frequency lines with the largest amplitude values and their differences. In order to obtain a statement on the quality of the determination of these fundamental frequencies, the deviations of the differences of the fundamental frequencies, and the deviations of the frequencies of harmonics of the fundamental frequencies, as well as the amplitude values are assessed as linguistic variables and membership functions, then associated with each other with predetermined rules based on a fuzzy rule.

However, only three frequency lines are considered in this case. Frequency lines with lower amplitude size are likewise less recognized, as well any existing individual lines within the frequency spectrum. Since this method allows only individual fundamental frequencies to be determined, it is not possible to detect a complete frequency lines set or a complete frequency line pattern. Furthermore, no duplicates are determined by the frequency lines using the above method, which may provide an indication of several driving propellers.

The invention is based on the task for provision of a method which automatically, i.e. without operator assistance, recognizes a possible complete frequency line pattern within at least one amplitude spectrum. In this case, a target-related frequency line pattern of one or more definitive associated frequency lines, and possibly existing individual lines, are composed to achieve this.

The invention solves this problem by the characteristics of a method for determining a frequency line pattern according to claim 1, and a corresponding apparatus for performing the method with the characteristics of claim 15.

In order to detect and classify a vehicle, especially a water vessel, its emitted operating noise level is received by a sonar system as a received signal together with the ambient noise. Then, this reception signal is transformed into at least one frequency spectrum to produce a corresponding representation as a function of frequency, for the purpose of evaluation, where the frequency spectrum is typically composed of its amount, the amplitude spectrum and its phase, and the phase spectrum.

The amplitude spectrum shows frequency lines outstanding from those generated by the general noise, for turbines, transmissions, generators, pumps, etc. A frequency line is thereby a frequency or a low frequency region which extends in accordance with a predetermined frequency resolution over multiple frequency cells.

According to the inventive method, the frequency lines are sorted within the amplitude spectrum in a pre-processing module. The sorting thereby takes place on the basis of the associated amplitude values of the frequency lines. It is preferred that the frequency lines organized in descending order and sorted by their amplitude size into a list, where the list begins with each frequency line that has a maximum amplitude. If more than one line frequency has the same amplitude level, then the first frequency line stored in the list is that line having the lower frequency. Furthermore, in the processing module, the frequency lines are assigned according to rank.

In a further step of the method according to the invention, a predetermined number of the sorted frequency lines are selected in a module for parameterization and line selection. The number of selected frequency lines is limited in order to advantageously avoid detection of random frequency sets of lines by means of this inventive method.

Furthermore, several thresholds are set. With the help of the threshold values, noise suppression and particularly strong frequency lines are advantageously selected. The threshold values are set so that, for a visual representation, especially a waterfall display, a sufficient number of frequency lines are detected and all visually striking amplitudes can be recorded by an operator.

The selected frequency line that takes into account at least one threshold value is compared to them in order to build the so-called pairs of lines.

In a further step of this inventive method, those pairs of lines are combined in a module for determining the provisional frequency line sets, which have approximately the same fundamental frequency. These combined line pairs form a provisional frequency line set. Here, a frequency line set refers to an amount of frequency lines having a substantially constant frequency spacing (distance between them). If there is a sequence of frequency lines with approximately constant frequency intervals, then this concerns a definitive frequency line set. A frequency line set can be also considered when some frequency lines are not present within the classification.

If a preliminary frequency line set presents special features, such as a high number of frequency lines, a regular structure and/or a high number of strong frequency lines and this preliminary frequency line set cannot be derived from other pre-determined final frequency line sets, for example, due to a multiple of the fundamental frequency, then the preliminary frequency line set is a final frequency line set.

A parameter list is filed with a plurality of parameters for the preliminary frequency line set, including various information about the provisional frequency line set. Based on these parameters, an evaluation of the preliminary frequency line set takes place.

In a subsequent process of elimination, the final frequency line sets are determined in a module established for determining final frequency line sets from the preliminary frequency line sets. The preliminary frequency line sets are evaluated, for this purpose, with a low rating and preliminary frequency line sets whose fundamental frequency is a multiple or a sub-frequency of a fundamental frequency of a predetermined final frequency line set are thereby discarded.

In the event that individual lines are detected in the amplitude spectrum, these are recorded together with the final frequency line sets of a target at a frequency line pattern module for a target-related frequency line pattern that is as complete as possible.

The frequency line pattern of a detected object includes those frequency lines that relate harmoniously to each other, i.e. whose frequencies form a multiple of a fundamental frequency. Such frequency lines are recorded in a final frequency lines set. This may lead to detection of several final frequency lines sets for an object. Furthermore, the frequency line pattern includes any existing individual lines.

Advantageous features of a sound source can be derived from the issued frequency line pattern. Characteristic parameters are issued for each detected frequency line pattern, in particular fundamental frequency, number of sheets, particularly striking frequency lines, quality assessment, etc.

Based on these parameters, an advantageous rough classification of a detected vehicle can be made.

The automatic determination of the frequency line pattern enables the advantageous implementation of an automatic sound classification system. Thus, the inventive method is particularly suitable for use in automatic classification. The inventive method also serves to relieve an operator, because this can determine an automatic raw classification based on the issued frequency line patterns and their parameters, which the operator can, if necessary, “re-classify”.

In a preferred embodiment of the invention, the line pairs of frequency lines are compared with a sufficiently high amplitude and it is checked whether they are harmonious. Line pairs are formed with a corresponding fundamental frequency from a first frequency line and a second frequency line, where the first frequency line to be compared has a frequency greater than the frequency of the second frequency line to be used in comparison.

A line pair is considered to be balanced, either when the frequency of the first frequency line is a multiple of the frequency of the second frequency line, or when the frequencies of the two frequency lines to be compared is a multiple of the magnitude of the frequency difference between the two frequencies of the compared frequency lines.

If the first condition applies, the frequency of the second frequency line is considered to be the fundamental frequency of the line pair. If the second condition applies, the frequency difference is considered to be the fundamental frequency of the line pair.

In a further preferred embodiment of the invention, the frequency spectrum is determined by means of a DEMON (Detection of Envelope Modulation on Noise) analysis or LOFAR (Low Frequency Analysis and Recording) analysis. In the LOFAR analysis, a frequency spectrum and amplitude spectrum generated by an operating noise emitted from a vehicle is highlighted from the general noise the frequency lines in the low frequency range. Since these frequency lines are caused by the frequency of operating systems and other equipment on board of the vehicle, this low-frequency range is well suited to the detection and classification of the vehicles.

In the DEMON analysis, the high-frequency component of the received noise of the detected vehicle is demodulated over a band-pass and an envelope demodulator. The frequency spectrum and amplitude spectrum generated provides thereby information about the number of operating propellers, sheets number and speed, factors that can be determined from the vehicle type.

Preferably, the inferred amplitude spectrum is normalized through magnitude formation of the frequency spectrum. Thus, the frequency amplitudes are aligned across the whole frequency range and considered for determination of the frequency line pattern, excluding the relative maxima. This has the advantage that the amplitude spectrum is independent of the distance between the detected vehicle and the operating noise volume emitted by it.

Furthermore, the frequency spectrum and the amplitude spectrum is averaged over a predetermined time period. This is used, on the one hand, for noise suppression and on the other hand for the representation of reliable frequency lines over time.

The frequency analysis is performed at predetermined time intervals. It is thus possible to create the so-called LOFARgramm or DEMONgramm, where the spectral lines occurring at them mark the detected vehicle. In such an illustration, the time-axis extends vertically, and the frequency axis, horizontally. By suitably averaging the amplitude spectra over a period of time, even those frequency lines that do not occur with any frequency analysis are detected, for example, environmental influences that temporarily suppress individual frequencies in the received noise.

By means of the preferred method and the preferred device, both the DEMON spectrum and the LOFAR spectrum can be considered in the implementation. Based on the LOFAR spectrum and the DEMON spectrum, one or more frequency lines sets are determined. Eventual existing individual lines are additionally determined from the LOFAR spectrum. For a subsequent classification, the frequency lines sets from the DEMON- and LOFAR-spectrum, as well as the eventual individual lines can be combined together within a frequency line pattern which allows derivation of target-specific noise characteristics.

In a further preferred embodiment of the invention, the threshold values are dynamically set in a module used for parameterization and line selection, where all thresholds are above a given value for a noise level. The basis for setting the threshold values enables the previously determined maximum amplitude and the minimum amplitude of the selected frequency lines. A high threshold, referred to herein as “high”, is set so that when a small number of frequency lines stored in the list of frequency lines is detected, their amplitudes are the greatest. This threshold is thus advantageous, particularly to high frequency lines in the amplitude spectrum.

Another possible threshold value, herein referred to as “base”, determines those frequency lines that significantly stand out from the noise level. The invention assumes that each frequency line pattern that needs to be determined shall include some relatively high frequency lines, since these frequency line patterns would not, otherwise, be manually detectable by an operator.

Another threshold value, here referred to as “hi”, determines those frequency lines that only present a reduced difference from the noise level. This has the advantage that the low frequency lines that are associated with a frequency line pattern can also be detected.

Another threshold value, herein referred to as “II”, determines those frequency lines that are valid as individual lines. If the amplitude spectrum shows a spectrum of the LOFAR analysis, this threshold value is of type “II”-individual lines in the LOFAR spectrum.

In a further embodiment of the invention, the parameters of the preliminary frequency lines set take into account the amplitude values of the frequency lines associated to the preliminary frequency lines, and also the relative position of the frequency lines among each other.

Another parameter takes into account, for example, the number of frequency lines that have exceeded the “high” threshold and thus have a particularly strong amplitude. frequency lines sets with several high amplitudes are therefore rated higher. The position of the frequency lines is taken into account, by the number of frequency lines set as its parameter, which follows from each other in a sequence, i.e. which forms a frequency lines set without amplitude loss. Similarly, the line density can be taken into account as a parameter.

Furthermore, the fundamental frequency associated with the preliminary frequency lines set is considered as a measured and/or calculated size of the parameter.

The invention is not limited to the above listed parameters. However, these are considered. But other parameters are conceivable for the process, which could describe the properties of the preliminary frequency lines set and could be used in the evaluation of the preliminary frequency lines set. A preliminary frequency lines set thus represents a vector with multiple parameters.

In a further version of the invention, the frequency lines are determined in an individual line module, and they are still contained in the amplitude spectrum obtained after subtraction of the determined final frequency lines sets from the amplitude spectrum. If these frequency lines also exceed a pre-determined threshold value for determining the individual lines, these frequency lines are determined as individual lines. By capturing such individual lines, in particular from the LOFAR spectrum, a complete line frequency pattern of a detected foreign object along with the final and valid frequency lines sets can be advantageously produced.

According to a preferred embodiment of the invention, the frequency line patterns of the amplitude spectrum that are to be determined, are evaluated using a quality parameter. The quality or the quality parameter is dependent on the sequence, the number and size of the amplitudes, the line density and/or the fundamental frequency of the associated frequency lines. This may be advantageous with respect to a statement of, for example, probability of a result to be met. The operator is then free to decide whether he allows less reliable values to be classified.

According to another preferred embodiment of the invention, the preferred method when no frequency line pattern is detected is a repeated performance of the method, with different parameters, in particular with a different frequency tolerance and/or modified threshold values. The aim of the method is to identify all possible frequency lines sets, as well as all existing individual lines, which are also visible to an operator. Therefore, the above parameters are initially set very tight. If no frequency line patterns are detected with these parameters, a higher tolerance parameter is specified.

Furthermore, special cases or situations can be considered where, for example, an operator would visually recognize a frequency line pattern, although the preferred process does not provide a frequency line pattern as a result. With a further implementation of the process, these situations or specific cases and/or additional manual input requirements by the operator are taken into account before calculating the provisional frequency lines set. This has the advantage that irregular frequency lines sets, which include only very few frequency lines, recognized by an operator due to their amplitude and structure, will be found automatically.

In a further preferred embodiment of the present invention, the own noise made by the vessel is taken into consideration in the implementation of the preferred method. Those frequency lines in the amplitude spectrum which arise due to the inherent own noise made by the vessel will be, advantageously, not taken into consideration. This has the advantage that is not possible to erroneously interpret a possible occurring own noise made by the vessel as individual lines. Thus disturbances in the frequency line pattern are avoided advantageously.

In a further preferred embodiment of the invention, in the case that two or more frequency lines of a set of adjacent frequency lines exists with a small frequency difference, then an additional feature to that frequency lines is retained. With this feature, for example, the presence of duplicates is specifically characterized by the frequency lines. As part of a classification, it can be advantageous to identify them, for example, on a ship having two propellers and/or two machines.

According to another preferred embodiment of the invention, the corresponding parameter to be determined for the frequency line patterns, in particular propeller information, machine engine information and/or transmission information, is established as a result. These parameters are necessary for the classification procedure to follow.

By means of an output along with the frequency line pattern, a possible automatic classification becomes advantageous.

In a further preferred embodiment of the invention, the determined frequency line pattern is measured in due time. For this, the previously found final frequency lines sets that are associated with the frequency line patterns, are first compared with the new amplitude spectrum. A match of the frequency lines set with the amplitude spectrum leads advantageously to a higher valuation of the associated frequency line pattern.

The use of a history of results has therefore the advantage of levelling the frequency line patterns that have been determined in the individual time periods.

In a further preferred embodiment of the invention, the frequency spectrum or the amplitude spectrum has identified a detected foreign object from the direction of the sound or a sound that extends over a greater sound-bearing area, in which a plurality of foreign objects may be present. The advantage of covering a larger sound-bearing area is that the method can run in the background, as a system support. In a corresponding recognition of a frequency line pattern, the method can for example, promptly provide the operator with a rough classification or give notification of new lines or possibly speed changes.

According to a further preferred embodiment of the invention, those frequency lines sets are sorted to determine the final frequency lines set by means of the method used for elimination, so that the fundamental frequencies will be approximate to a multiple of the fundamental frequency of the previously pre-determined preliminary frequency lines set that has a higher rating. Furthermore, for those sorted frequency lines sets, the fundamental frequency is approximately equal to a portion of the previously pre-determined preliminary frequency lines set. Then the preliminary frequency lines set is used with the next rating for the exclusion method. In this way, all of the derived frequency lines sets are advantageously sorted out, as they form subsets of a frequency lines set.

According to an alternative embodiment of the invention, the inventive apparatus shows one or more means for performing the method steps described above.

Further advantageous embodiments of the invention emerge from the dependent claims and also in connection with the accompanying drawings illustrated in detailed embodiment examples. In the drawings is shown:

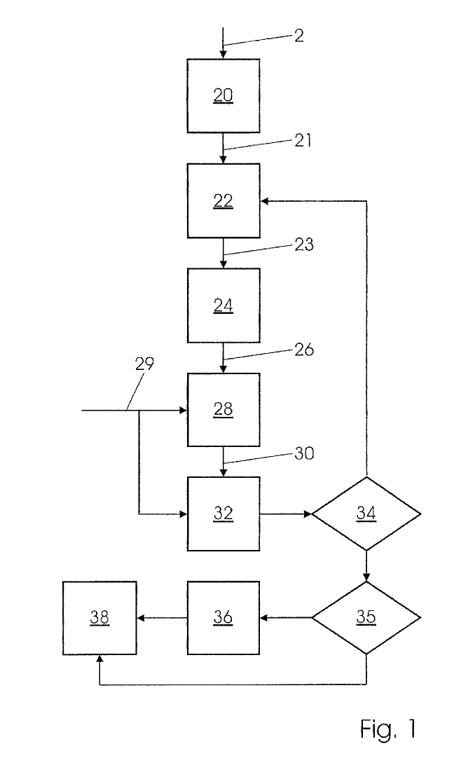

FIG. 1 a schematic representation of a flow chart of the invention method

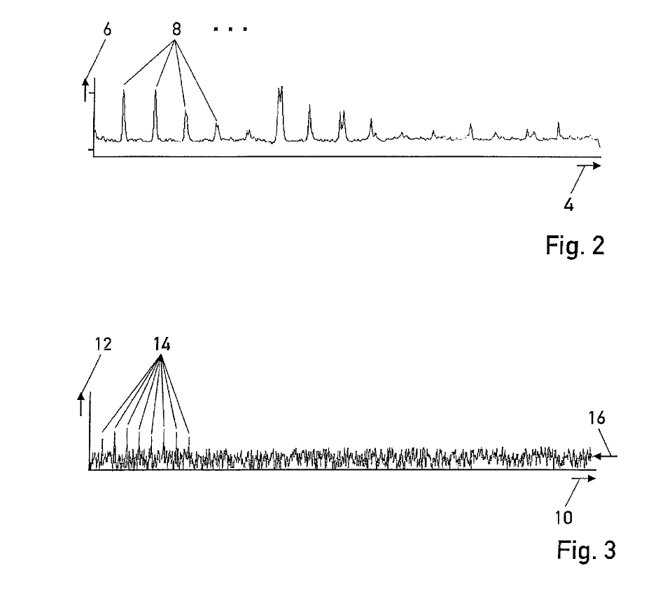

FIG. 2 an exemplary depiction of a DEMON spectrum and

FIG. 3 an exemplary depiction of a LOFAR spectrum.

FIG. 1 shows a schematic representation of a flow chart in order to explain an embodiment of the method described in the invention. It is assumed, in this embodiment example, that a foreign object, especially a foreign vessel has been detected and at least one device-related or direction-related frequency spectrum is present, from the signals received at a sonar installation of the noises emitted from this object.

The frequency spectrum of the signal received at the sonar system can be derived from the received signal by calculation, for example, of a Fourier transformation, and, consists of the result, hereinafter referred to as amplitude spectrum, and the phase, called phase spectrum, together. For simplicity, the description under the spectrum of a received signal understood as an amplitude spectrum of the received signal or a signal derived from the amplitude spectrum.

For carrying out the method according to the invention, it is further requested that input data 2 shall be made in the form of a resulting from a DEMON spectrum of a DEMON analysis and/or one LOFAR spectrum resulting from a LOFAR analysis. Preferably normalized spectra are used as input data 2, so that, when the amplitudes of the frequency, especially by LOFAR spectrum, the frequency levels are aligned in the entire frequency range. Furthermore, the spectra are integrated with time, obtaining therefore a better noise rejection. Here, the integration period can be manually set by the operator or can be implemented in advance in the method. Preference is given to carrying out the method according to the invention, and for each detected object, a DEMON spectrum and LOFAR spectrum is assumed, in order to obtain a comprehensive frequency line pattern. However, if several LOFAR spectra are available, these are summarized accordingly.

It is further assumed that in addition to the frequency lines of the foreign object, natural frequency lines also occur, due to the noise sources of the own noise made by the vessel in the spectrum, particularly in the LOFAR spectrum. These natural frequency lines are taken into account in the invention method.

FIG. 2 shows a representation of an exemplary DEMON spectrum. The spectrum is plotted against the frequency on a horizontal axis 4. The corresponding normalized frequency amplitudes are represented on a vertical axis 6. In this exemplary DEMON spectrum, several significant frequency lines 8 can be found, from which a frequency lines set or fundamental frequency and/or a journal frequency of a propeller can be derived.

FIG. 3 shows a representation of an exemplary LOFAR spectrum. The spectrum is also plotted here over the frequency on a horizontal axis 10. The vertical axis 12 shows the values for normalized frequency amplitude or frequency level. Also in this embodiment, several significant frequency lines 14 can be seen, which protrude from the general noise level 16. Based on the LOFAR spectrum, noise sources, such as diesel engines, turbines, generators, pumps and/or fans can be determined.

According to FIG. 1, the amplitude values of the DEMON or LOFAR spectrum are transferred as input data 2 to a pre-processing module 20. Only the maxima of the DEMON or LOFAR spectrum is considered, as shown in FIG. 2 or FIG. 3. In the pre-processing module 20, the frequency lines are sorted in descending order according to their amplitude size, and assigned a corresponding ranking. The ranking list and the amplitude values 21 form the basis for establishing threshold values in the module 22 used for parameterization and line selection.

Further, in the preprocessing module 20, an initial rough estimate is made in order to detect special cases. In these special cases concern, for example, cases in which one of the strongest frequency lines is a multiple of another strong frequency line and/or multiples of this frequency lines exists. The special cases determined this way are considered for the final selection process of the frequency lines sets.

Threshold values are set in the module 22, which are used for parameterization and line selection. This concerns amplitude-dependent threshold values that are defined as relative to a minimum amplitude or a maximum amplitude of a selection of allowed frequency lines 21. The number N of frequency lines to be selected should be chosen so that a sufficient number of frequency lines are selected insofar as all the frequency lines sets and any eventually existing individual lines can be detected when using a LOFAR spectrum, but recognition of random frequency patterns is avoided. In this case, the number N of frequency lines to be selected are each fixed separately for the DEMON spectrum and the LOFAR spectrum, or set manually by the operator.

FIG. 2 shows the first nine frequency lines 8. These are provided with an associated rank 1 to 9, in accordance with the method proposed by the invention, which corresponds to the amplitude value.

The threshold values are set based on the allowed frequency lines N. In this exemplary embodiment, the threshold “base” controls a subset of frequency lines, which belong to a possible frequency lines set. A further threshold level “hi” regulates a subset of frequency lines that are allowed first in finding frequency lines sets, and is smaller than the “base” threshold value. When a DEMON spectrum is used based on the maximum amplitude, a further maximum threshold value defines a small number of frequency lines in the DEMON spectrum. This is a number that shows the largest amplitude values, and is referred to herein as “high”. If the input data 2 contains amplitude values of a LOFAR spectrum, then there is a separate threshold value, referred to herein as “II”, used for choosing possible individual LOFAR lines belonging to none of the final frequency lines set.

Those frequency lines 23, that are allowed on the basis of the threshold value “base” for finding frequency lines sets, are transferred to a differential matrix module 24. It is preferred that the frequency lines are sorted in descending order according to their frequency.

The difference matrix module 24 is used to determine harmonic line pairs. For this, all authorized frequency lines 23 of a spectrum are compared with each other and examined to determine whether the pairs of lines are harmonious. If the frequency lines 23 are harmonious with each other, they are placed in a difference matrix 26 with their associated fundamental frequencies.

A harmonic relation between frequency lines is present when the frequency of the first frequency line is a multiple of the frequency of the second frequency line or the frequencies of the two frequency lines to be compared is a multiple of the magnitude of the frequency difference of the two frequency lines. Thereby, the frequency of the first frequency line to be compared is greater than the frequency of the second frequency line to be compared. This ensures that each visible frequency lines set has corresponding pairs of lines at the fundamental frequency and is recognized in the difference matrix 26. The invention accepts that for each frequency lines set of interest, either the fundamental frequency is recognized as a frequency line, or at least two successive frequency lines shows a harmonic relation.

In the calculation of the difference matrix 26, in addition to the fundamental frequency, it also possible to store information about a possible duplicate in the frequency lines.

Duplicates are understood as two or more adjacent frequency lines that have a very low frequency difference. Since such duplicates occur for example, for vessels with two propellers and/or two engine machines, the presence of duplicates in a frequency lines set is a characteristic feature of the vehicle and is thus relevant for a subsequent classification. If a pair of lines of the difference matrix 26 receives the additional “duplicate”, then this feature will be stored with an associated probability in the difference matrix 26. If a frequency lines set contains several frequency lines with the characteristic “duplicate”, then the probability increases accordingly.

By means of the difference matrix 26, each frequency lines can be let in a module 28 for determining preliminary frequency lines sets, namely those frequency lines which have essentially the same fundamental frequency, summarized in a preliminary frequency lines set. Here, a preliminary frequency lines set has at least two pairs of lines that have approximately the same frequency spacing. If there are only two frequency lines and these are harmonious, then this pair of lines may also form a frequency lines set.

In the module 28 for determining preliminary frequency lines sets, the preliminary frequency lines sets are further evaluated. For this, those parameters are defined from a set of parameters—that are used for an assessment of the preliminary frequency lines sets. The determination of these parameters is possible via a manual specification 29 completed by operator intervention or firmly implemented in the method. Potential parameters may be a calculated and/or a fundamental frequency measured, representing the position of the first contained frequency line, the number of frequency lines contained in the preliminary frequency lines set, the number of frequency lines whose amplitude exceeds the value of “high” threshold or represents a value for the line density. The invention takes into consideration, but is not limited to, the above parameters. More than that, any parameter can possibly be imagined, that allows an assessment of the preliminary frequency lines sets. Thus, the assessment is dependent on the number of contained frequency lines, the sequence of the frequency lines, the number of high frequency lines, and a value related to the line density. Based on the specified parameters, an associated assessment factor is calculated at each preliminary frequency lines set. Thus the preliminary frequency lines sets with a high sequence and a large number of frequency lines with a large amplitude obtain, for example, a high assessment factor.

According to FIG. 1, the determination of the final frequency lines set or of the final frequency lines sets takes place in a corresponding module 32.

These preliminary frequency lines sets are transferred to the module 32 with their associated assessment factors 30. First, it is checked whether manual specifications or results of the rough estimate of the pre-processing module 20 are present. These will be considered, and preliminary frequency lines sets that correspond to the manual specifications as well as relatively reliable results of the rough estimation are preferential.

Then the preliminary frequency lines sets are sorted according to their assessment factors. Minimum requirements or maximum requirements can be also taken into account. For example, a minimum number of frequency lines, a minimum number of successive frequency lines and/or a minimum fundamental frequency and/or a maximum fundamental frequency can be taken into account, and they can, thereafter, lead to the elimination of individual preliminary frequency lines sets.

It will be checked by a process of elimination if several preliminary frequency lines sets belong to a final frequency lines set, i.e. whether concerns the frequency lines sets with a multiple of the fundamental frequency. For this purpose, the preliminary frequency lines set by the maximum assessment value is initially determined. All preliminary frequency lines sets whose fundamental frequency is a multiple of the fundamental frequency of the preliminary frequency lines set with the maximum assessment value are rejected during the process of elimination.

In a next step, the next preliminary frequency lines set is determined with the next best assessment parameter. Then again, all the provisional frequency lines sets are discarded when their fundamental frequency is a multiple of the fundamental frequency of the particular frequency lines set. In this way, a list is created with relevant preliminary frequency lines sets. Preferably, this list is limited to a few sets.

To determine the final frequency lines sets, the frequency lines of the relevant preliminary frequency lines sets are checked again in the module 32, to see if all frequency lines that are shown within the relevant preliminary frequency lines set actually have a frequency that is approximately a multiple of the fundamental frequency pertaining to the frequency lines set and have an amplitude that exceeds the threshold value “hi”. If these conditions are met, the relevant preliminary frequency lines set is declared as pertaining to a final frequency lines set. For each frequency lines set, characteristic parameters are also determined, such as the fundamental frequency, the number of sheets and the number of drive shafts, particularly the striking frequency lines as well as a value for a quality assessment of the result.

The quality assessment is dependent on the number of the frequency lines, the number of associated frequency lines with a high amplitude, of fundamental frequency, of sequence, and/or of frequency lines density. Preferably, the value for the quality assessment stands in a range from 0.1 to 1.0, where the value 1.0 is a very reliable result, and the value 0.1 is a particularly uncertain result.

In the event that no final frequency lines set was determined but significant frequency lines are present, the invention method provides a decider 34, according to FIG. 1. If no final frequency lines set is detected, the parameters, in particular the search window and threshold values change in the module 22 insofar as a larger tolerance range is created and the search for frequency lines sets as outlined above is performed again. The adjustment and modification of parameters for the detection of possible frequency lines sets can be done several times.

It will also examine whether specific cases occurs, in which an operator could detect the frequency lines set. This may be the case, for example, when there is a DEMON spectrum, if a frequency line is only detected for the propeller blade, and a frequency line for the drive shaft. In the presence of a LOFAR spectrum, similar special cases can occur. In addition to manual specifications, these special cases 29 are considered in the module 32. If there are strong variable frequencies and amplitudes of the frequency lines, it is possible to first filter the input data 2 for re-implementation of the method. Over a period of time, the frequency lines are then compared with the preceding frequency lines, which leads essentially to a levelling of the amplitude of the frequency lines. In addition, under this filtering, relevant parameters such as quality or incidence are stored to the frequency lines, which result in higher amplitudes being weighted more heavily than weak amplitudes.

If, after repeatedly carrying out the invention method, no final frequency lines sets have been determined, a final search cycle checks whether a “strong” frequency line is contained in the amplitude spectrum whose frequency is a multiple of the frequency of another “strong” frequency line. If this is the case, these frequency lines are allocated to a final frequency lines set.

Another decider 35 in the exemplary flowchart shown in FIG. 1 checks whether there is a DEMON spectrum or LOFAR spectrum at the input data 2. In the event that a LOFAR spectrum is present, after determination of the final frequency lines sets and after sorting the corresponding frequency lines in the LOFAR spectrum over the individual line module 36, a check for any existing individual lines is done.

For this purpose, those frequency lines whose amplitudes exceeds the threshold value “II” will be picked out. This is well above the threshold value, which indicates the frequency line that belong to a possible frequency lines set. LOFAR individual lines with a relatively high amplitude, which are not assigned to a final frequency lines set, are thus assumed to be individual lines. These individual lines are transferred together with the determined final frequency lines sets to a frequency line pattern module 38 in order to determine an appropriate target-related frequency line pattern.

In the event that there is a DEMON spectrum at the input data 2, the determined final frequency lines sets are transferred to the frequency line pattern module 38 directly from the decider 35.

In the frequency line pattern module 38, the final frequency lines sets of the DEMON spectrum and the final frequency lines sets as well as the individual lines of the LOFAR spectrum are detected in time, and then combined into a frequency lines pattern in order to gain information about the possible propeller units of one or more vehicles. The frequency lines sets or the frequency lines patterns are assessed in time, i.e. the previously found frequency lines sets are first compared with the new spectra. All frequency lines pattern and/or frequency lines sets are provided with a value for quality assessment. Consequently, any frequency lines patterns that are confirmed over time, or are sufficiently pronounced, constitute a result good for display and are stored in a history.

The invention method can be used advantageously to find several final frequency lines sets. Thereby, for example, at a DEMON spectrum, noises from multiple propellers will also be detected, for example, noises from a vessel with one or two propellers or a target intersection or noise coming from more vessels can be assigned in order. Furthermore, complex frequency lines patterns and individual lines can be found with the invention method in a LOFAR spectrum. This allows the method to be used advantageously as support for the operator when entering the noise characteristics. In addition, a support system is possible with the method by reporting the new frequency lines and/or speed changes. Furthermore, the method can be used for automatic classification of noise. Generally, use in unmanned systems is also possible.

If a larger area of detection is selected for the implementation of the chosen method, especially by sonograms based on accumulation, it is possible to obtain more contacts, i.e. several foreign objects are detected within the given detection area. This leads to complex frequency lines patterns, because they are no longer target-led. When using a DEMON spectrum as input data 2, this multi-contact situations can be advantageously resolved by the method, based on several final frequency lines sets.

All the features mentioned in the above description of the figure, claims and introduction are used both individually and together in any combination. The disclosure of the invention is thus not limited to the feature combinations that are described or claimed. Rather, all feature combinations are considered to be disclosed.

1. Method for determining a frequency line pattern within at least one amplitude spectrum which is obtained from acoustic signals that have been emitted from at least one detected vehicle and received by of a sonar installation, the method comprising:
a) sorting the frequency lines in the amplitude spectrum, descending, by amplitude size, starting with each frequency line that has a maximum amplitude, and setting an order precedence,
b) selecting a predetermined number of already sorted frequency lines, and setting a plurality of threshold values,
c) comparing the frequency lines with each other to form pairs of lines, considering at least one threshold value,
d) summarizing the pairs of lines with approximately the same fundamental frequency to a preliminary frequency lines set, and assessing the preliminary frequency lines set based on a plurality of parameters, in particular the number, sequence, amplitude and density of the frequency lines,
e) determining the final frequency lines sets from the preliminary frequency lines sets using a process of elimination, by taking into account the assessment of the preliminary frequency lines sets and one or more threshold values, and
determining the frequency lines pattern of at least one detected vehicle by combining any possible existing individual line and the final frequency lines sets of the amplitude spectrum or spectra.

2. Method according to claim 1,
wherein
the pairs of lines are formed with an associated fundamental frequency from a first frequency line and a second frequency line, wherein the frequency of the first frequency line is higher than the frequency of the second frequency line, and wherein a pair of lines is formed, either when the frequency of the first frequency line equals a multiple of frequency of the second frequency line, and then the frequency of the second frequency line is the fundamental frequency of the line pair, or the frequencies of the two frequency lines to be compared equal a multiple of the magnitude of the frequency difference between the two frequencies of the compared frequency lines, and then the amount of the frequency difference is the fundamental frequency of the pair of lines.

3. Method according to claim 1,
wherein
the amplitude spectrum or spectra is/are determined by one or both of Detection of Envelope Modulation on Noise “DEMON” analysis and a Low Frequency Analysis and Recording “LOFAR” analysis, wherein the amplitude spectrum or spectra is/are averaged and normalized over a predetermined time period.

4. Method according to claim 1,
wherein
the threshold values above a determined noise level are determined dynamically based on maximum and minimum amplitude of the frequency lines selected at b), wherein a threshold value determines any of:
a plurality of frequency lines in the amplitude spectrum with the largest amplitude values,
another threshold value for frequency lines in the amplitude spectrum, which significantly stand out from the noise level,
a further threshold value for frequency lines in the amplitude spectrum, which only slightly stands out from the noise level, and
a further threshold value for frequency lines in the amplitude spectrum, which are considered to be individual lines.

5. Method according to claim 1,
wherein
the parameters of the preliminary frequency lines set at d) take into account the amplitude values of the associated frequency lines as well as the relative position of the frequency lines to each other, and/or the fundamental frequency associated as a measured and/or calculated value.

6. Method according to claim 1,
wherein
the frequency lines in the amplitude spectrum, which are contained by a subtraction of the determined frequency lines sets in the amplitude spectrum and have exceeded a predetermined threshold value for determining individual lines, are determined as individual lines.

7. Method according to one of the preceding claim 1,
wherein
the determined frequency lines pattern is assessed for at least one amplitude spectrum by of a quality parameter.

8. Method according to claim 1,
wherein
for the case that no frequency line pattern is detected, the process is repeatedly carried out again with modified parameters.

9. Method according to claim 1,
wherein
noise vessel at which the method is carried out is taken into account in the implementation of the method, and no frequency lines in the amplitude spectrum, which arise from this noise, are included in the method.

10. Method according to claim 1,
wherein
in the case where frequency-adjacent lines exist in two or more frequency lines of a frequency line set with a small frequency difference, a vehicle feature is identified.

11. Method according to claim 1,
wherein
the parameters corresponding to the determined frequency lines pattern are established as results.

12. Method according to claim 1,
wherein
the determined frequency lines pattern is evaluated over time.

13. Method according to claim 1,
wherein
the amplitude spectrum of a detected foreign object indicates a certain detection area or has a larger detection area in which a plurality of foreign objects are present.

14. Method according to claim 1,
wherein
all preliminary frequency lines sets whose fundamental frequencies approximate a multiple of a fundamental frequency of a provisional pre-determined frequency lines set will be sorted by the process of elimination.

15. Apparatus for determining a frequency line pattern within at least one amplitude spectrum that is generated from acoustic signals that have been emitted from at least one detected vehicle and received by a sonar system, comprising:
a pre-processing module which is configured to sort frequency lines in the (or each) amplitude spectrum, where the frequency lines are sorted in descending order based on amplitude size, starting with the frequency line that has a maximum amplitude, and establishing a ranking order of the frequency lines,
a module for setting parameters and line selection, which is configured to select a predetermined number of sorted frequency lines and to set a plurality of threshold values, as well as to build a difference matrix module where the matrix module is designed through a comparison of frequency lines and by taking into account at least one threshold value of the line pairs,
a module for determining the preliminary frequency lines sets that is configured as to combine the pairs of lines that have approximately the same fundamental frequency with a preliminary frequency lines set, and, based on a plurality of parameters, in particular the number, sequence, amplitude and density of the frequency lines, to evaluate them,
a module for determining the final frequency lines sets which is configured to determine final frequency lines from the preliminary frequency lines sets, by an exclusion procedure and by taking into account the evaluation of the preliminary frequency lines sets and of one or more threshold values, and
a frequency line pattern module that is configured to determine a frequency line pattern for at least one detected vehicle, by combining any eventually existing individual lines and the final frequency line sets of the amplitude spectrum and spectra.

16. Method according to claim 7, wherein the quality parameter comprises any of sequence, number, amplitude, density and fundamental frequency of the associated frequency lines.

17. Method according to claim 8, wherein the modified parameters comprise one or both of search window and threshold values.

18. Method according to claim 11,
wherein
the parameters established as results are information about the propeller, engine or transmission.
